(19) United States
(12) Patent Application Publication
(10) Pub. No.: US 2002/0085533 A1
(43) Pub. Date: Jul. 4, 2002

(54) Enhanced cell range in time division duplexed utran

(76) Inventors: Stephane Eloy, Courbevoie (FR); Hamid Reza Falaki, Swindon (GB); Hamid Reza Karimi, Swindon (GB); Yvon Le Goff, Perros-Guirec (FR); Gordon Peter Young, Bracknell (GB)

Correspondence Address: Docket Administrator (Room 3J-219), Lucent Technologies Inc., 101 Crawfords Corner Road, Holmdel, NJ, 07733-3030, US

(21) Appl. No.: 10/021,384

(22) Filed: Oct. 29, 2001

(30) Foreign Application Priority Data
Nov. 13, 2000 (EP) 00310068.2

(51) Int. Cl. H04B 7/212

(52) U.S. Cl. 370/345; 370/442

(57) ABSTRACT

In a UTRAN operating time division duplexing, one time slot 22(11) in each frame is maintained in a no-transmit condition, all preceding time slots 22(1) to 22(10) being uplink time slots and all succeeding time slots 22(12) to 22(15) being down link time slots (or vice versa). Cell size is markedly increased.

### CROSS REFERENCE TO RELATED APPLICATION

This application claims priority of European Application No. 00310068.2 filed on Nov. 13, 2001.

### BACKGROUND OF THE INVENTION

1. Field of the Invention

The present invention relates to the Universal Mobile Telephone System (“UMTS”), and more particularly, a method and apparatus for enhancing the cell range of the Time Division Duplexing (TDD) option in the UMTS Terrestrial Radio Access Network (“UTRAN”).

2. Description of the Related Art

In a cellular mobile system, such as UMTS, each cell conventionally has a single source of transmission to and reception from the rest of the network. In a Time Duplexing Multiple Access (TDMA) system, the time delay for a transmitted signal to reach a mobile terminal and for the response signal to be received by the controlling base station, is one factor which limits the size of the cell.

In the third generation specification of the European Telecommunications Standards Institute (ETSI), the Technical Specifications for the UTRAN provide for two types of air interface. For macro cells, Frequency Division Duplexing (FDD) is specified while TDD is specified for pico cells and micro cells. The TDD option is further divided into two bands of chip rate operation, one with 3.84 Mcps (Mega chips per second) and the other with 1.28 Mcps.

The reasons for the cell sizes are as follows: the frame structure specified for the UTRAN TDD is shown in FIG. 1. Each frame consists of fifteen Radio Frequency (RF) time slots 10(1), 10(2), . . . 10(15) separated by guard periods GP, the total frame length equaling 10 milliseconds. The time slots (in this example) are alternately uplink and downlink, indicated by the arrows u and i.

The guard periods GP are each of length 96 chip and each guard period is used for the timing advance to allow for signal return delay. The time of a guard period may be realized by the following:

$$\frac{96 chip}{3.84 Mcps} = 25 microseconds .$$

FIG. 2 shows a Base Station (BS) 12 and mobile User Equipment (UE) 14. The cell size is limited by the speed of light, guard period, and the distance between mobile UE 14 and BS 12. To allow for a distance of travel 2x in the guard period, this limitation may be expressed by the following:

$$x = \frac{ct}{2} = \frac{300 , 000 km / s}{2} \times 25 microseconds = 3.75 km$$

where, c is the speed of light, t is a guard period, and x is the distance between UE 14 and BS 12.

Thus, the maximum cell size is 3.75 km for wideband TDD at 3.84 Mcps, and three times 3.75 km for narrowband TDD at 1.28 Mcps, assuming that the guard period is the only constraint on cell size. These ranges assume that there is no RF link budget constraint.

Commercially, the 3.84 Mcps TDD option of UTRAN has not been regarded favorably, by reason of the limited cell size.

### SUMMARY OF THE INVENTION

It is an object of the invention to provide an increased cell size with minimum modification to hardware and software.

According to the invention a method of operating a UTRAN by the technique of time division duplexing in which uplink and downlink data are provided in time slots, the time slots being grouped into frames of fixed length, characterized in that in each frame one time slot is maintained in a no-transmit condition, all time slots in the frame preceding said time slot being one of uplink or downlink time slots and all time slots succeeding said time slot being the other of uplink and downlink time slots.

Also, according to the invention, a Node B or a Radio Network Controller for a Universal Mobile Telephone System, the node B or Controller being arranged to configure time slots in data frames which it transmits to user equipment and to receive data frames having that configuration, characterized in that in every frame one time slot is maintained in a no-transmit condition, all time slots in the frame preceding said time slot being one of uplink or downlink time slots and all time slots succeeding said time slot being the other of uplink and down link time slots.

### BRIEF DESCRIPTION OF THE DRAWINGS

The present invention will be better understood from reading the following description of non-limiting embodiments, with reference to the attached drawings, wherein below:

FIG. 1 illustrates the known art;

FIG. 2 illustrates the known art;

FIG. 3 illustrates a modified TDD frame; and

FIG. 4 illustrates a UTRAN.

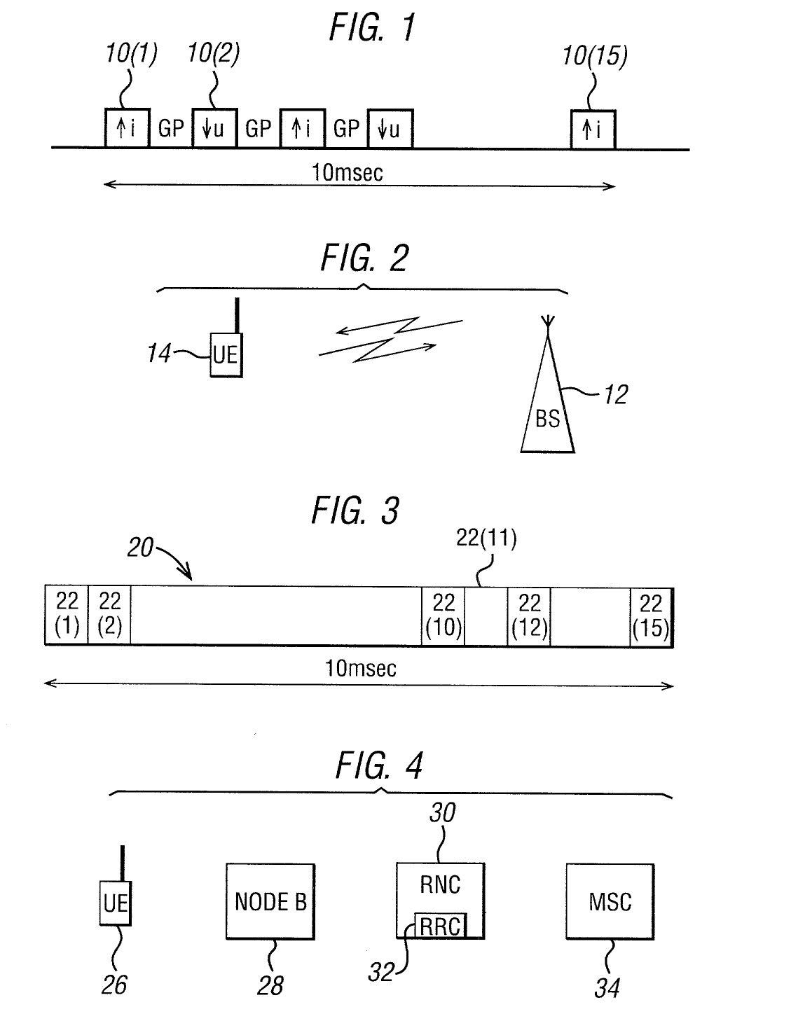

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

FIG. 3 shows a TDD frame 20 having fifteen time slots 22(1) to 22(15). One time slot 22(11) is maintained in a no-transmit condition, and is the switching point time slot. In the example, this is the eleventh time slot. All time slots 22(1) to 22(10) preceding the switching time slot 22(11) are uplink time slots and all time slots 22(12) to 22(15) succeeding switching time slot 22(11) are downlink time slots. The frame length remains at 10 milliseconds.

In effect, the time allowed for transfer of information to and from the mobile equipment may be expressed by the following:

$$\frac{10 milliseconds}{15} = 666.67 microseconds$$

and multiplication by the speed of light gives a maximum returned signal path of 200 km, thus the maximum distance of UE 14 from BS 12 is now 100 km.

The cell is now comparable in size with a UTRAN FDD cell.

FIG. 4 illustrates schematically a UTRAN according to the invention.

UE 26 communicates with Node B 28 which is controlled by a Radio Network Controller (RNC) 30 containing a Radio Resource Control (RRC) logical block 32. The RNC 30 is controlled by a Mobile Switching Center (MSC) 34.

By implementation of the invention, UE 26 can now communicate with Node B 28 up to a distance of 100 km.

Usually the invention will be implemented in the RRC 32, but it can alternatively be implemented in Node B 28. In either case the resident software is arranged to control the frame structure as described above. Since Node B 28 will continue to instruct UE 26 how to configure itself, no modifications to the mobile equipment are required.

A network operator has the opportunity, on network configuration, of selecting a larger cell size than has previously been possible with a TDD interface.

The removal of the time delay as a constraint on cell size in TDD has further advantages. Since a longer guard period is now provided, the power spectrum mask specification for the RF amplifier in the Node B28 can be relaxed, giving a financial saving, because the tolerance of the filtering within the RF system can be reduced. Also there is an on/off switching only once in every frame, any disturbance occurs at 100 Hz, i.e. nearly out of an adult's audible range, so that lower power and cheaper amplification can be used while retaining required emc performance.

Naturally, the transmission power and reception sensitivity of the hardware need to be capable of dealing with the greater distance involved in the larger cell.

In general, application of the invention is expected to result in a capacity reduction of only about 6.7%.

The invention can be applied in a packet switched network as described in the example, or in a circuit switched network.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. It is therefore contemplated that the appended claims will cover any such modifications or embodiments as fall within the true scope of the invention.

1. A method of operating a UTRAN by time division duplexing, wherein uplink and downlink data are provided in time slots grouped into frames, the method comprising:
maintaining a no-transmit condition in at least one time slot in each frame, wherein remaining time slots in the frame preceding said at least one time slot comprising an uplink or a down link time slot, and succeeding time slots of said at least one time slot comprising the other of the uplink or down link time slot of the remaining time slots.

2. A method according to claim 1, wherein said at least one time slot is not the first or last time slot in a frame.

3. A Node B for a Universal Mobile Telephone System, the Node B arranged for time slots in data frames transmitted to user equipment and to instruct user equipment to receive and transmit data frames arranged as the Node B, wherein each frame is arranged so that at least one time slot is maintained in a no-transmit condition, remaining time slots in the frame preceding said at least one time slot comprise one of uplink or down link time slots and succeeding time slots of said at least one time slot comprising the other of the uplink and downlink time slot of the remaining time slots.

4. A radio network controller for a Universal Mobile Telephone System, the radio network controller arranged for time slots in data frames transmitted to user equipment and to instruct user equipment to receive and transmit data frames arranged as the radio network controller, wherein each frame is arranged so that at least one time slot is maintained in a no-transmit condition, remaining time slots in the frame preceding said at least one time slot comprise one of uplink or down link time slots and succeeding time slots of said at least one time slot comprising the other of the uplink and downlink time slot of the remaining time slots.

5. A mobile telecommunications network having a UTRAN comprising at least one Radio Network Controller, the Radio Network Controller controlling at least one Node B, and user equipment communicating with a Node B, wherein uplink and downlink data are provided in time slots, the time slots being grouped into frames, and at least one time slot in each frame is maintained in a no-transmit condition, remaining time slots in the frame preceding said at least one time slot comprise uplink or down link time slots, succeeding time slots of said at least one time slot comprising the other of the uplink and downlink time slot of the remaining time slots.

6. A mobile telecommunications network according to claim 5, wherein the network comprises a packet switched network.

7. A mobile telecommunications network according to claim 5, wherein the network comprises a circuit switched network.
